(19) United States
(12) Patent Application Publication
(10) Pub. No.: US 2023/0257210 A1
(43) Pub. Date: Aug. 17, 2023

(54) SEPARATING DEVICE FOR A HANGING CONVEYOR SYSTEM

(71) Applicant: Dematic GmbH, Heusenstamm (DE)

(72) Inventors: Andreas Tinnacher, Voitsberg (AT); Thomas Peiser, Gratwein-Straßengel (AT)

(21) Appl. No.: 18/170,494

(22) Filed: Feb. 16, 2023

(30) Foreign Application Priority Data
Feb. 17, 2022 (DE) 102022103809.2

(51) Int. Cl. B65G 47/28; B65G 17/20; B65G 47/84

(52) U.S. Cl. CPC B65G 47/28; B65G 17/20; B65G 47/846

(57) ABSTRACT

A separating device for separating holding adapters in a conveying device for conveying hanging objects, wherein the separating device comprises two separating elements that are each designed as a disk having a plurality of entrainment elements, designed as pinion teeth, and which are mounted so as to be able to rotate in opposite directions with respect to one another in a plane and are arranged spaced apart from one another in such a manner that holding adapters can be conveyed through the separating elements, where, in one possible rotational position of the separating elements on an imaginary line between an axis of rotation of a first separating element and an axis of rotation of a second separating element, a pinion tooth of the first separating element and a pinion tooth of the second separating element are located with their end faces opposite one another.

### CROSS REFERENCE TO RELATED APPLICATION

The present application claims the priority benefits of German application no. DE 10 2022 103 809.2, filed on Feb. 17, 2022.

### BACKGROUND AND FIELD OF THE INVENTION

The invention relates to a separating device for separating holding adapters in a hanging conveyor device, and a system comprising such a separating device.

A conveying device for conveying hanging objects, such as e.g. items of clothing, bags and the like, is a sorting and distributing device and has an important role in intralogistics where it is frequently used as an interface between storage and delivery. In order to meet the increasing demands of customers, conveying devices undergo constant further development, in particular with respect to process safety and efficiency.

Generic conveying devices have rail profiles, on which holding adapters are mounted and guided. The holding adapters, preferably fitted with rollers, are mounted and guided in particular in a lower region of the rail profile, in particular in a so-called free running rail. The hanging objects are releasably fastened to the holding adapters, preferably below the free running rail. In addition, a conveying chain of the conveying device is disposed in the rail profiles and the holding adapters can be coupled to the conveying chain in order to be conveyed. For this purpose, entrainers of the conveying chain engage in particular on a head part of the holding adapter, which extends preferably into a region of the rail profile located above the free running rail.

In order to generate spacings between the holding adapters or objects fastened thereto before decision points or applications of the conveying device and thus to separate the holding adapters or objects fastened thereto for a process-safe further handling at the decision points or applications, so-called separating devices are provided in the conveying device, in particular on the rail profiles thereof.

Known separating devices are based upon a linear movement of a single elongated or bar-shaped separating element which can be displaced into a conveying path for the holding adapters. However, such separating devices have the disadvantage that the separating element must always be moved back to a starting position after a separating procedure. It can also be the case with such a separating device that the holding adapter stops in the separating device, i.e. is not conveyed onwards, and therefore the operating sequence is disrupted. Moreover, such separating devices are typically operated with a pneumatic cylinder. However, it is no longer permitted to use pneumatics in conveying devices for the purpose of conveying hanging objects.

DE 202 17 423 U1 also discloses a switch point of a gathering conveyor for goods hanging on hangers, at which hangers are fed from two directions and which do not constitute separating devices. At the switch points, two disks driven via a chain and having entrainers are provided for onward conveyance of the hangers. One disk conveys the hangers coming from a first direction and the other disk conveys the hangers coming from a second direction. The entrainers of the two disks are designed as entrainer pawls or pin entrainers. The entrainers of one disk operate with a rotational offset with respect to the entrainers of the other disk. In addition, in plan view the entrainers of one disk overlap the other disk and vice versa.

In addition, U.S. Pat. No. 5,501,552 A discloses a switch point of a conveyor system for conveying unstable objects, wherein the switch point is designed in a similar manner to that of DE 202 17 423 U1 and likewise does not constitute a separating device. The switch point comprises four star wheels, with which the unstable objects are conveyed onwards. At a pair of star wheels, the object is transferred from one star wheel to the other, wherein the two star wheels are, for this purpose, rotatably mounted in different planes and engage with the object in different planes. At another pair of star wheels, the arms of one star wheel operate with a rotational offset with respect to the arms of the other star wheel.

### SUMMARY OF THE INVENTION

The present invention provides a separating device, a system comprising such a separating device as well as a method for separating, with which process-safe separation can be effected.

In accordance with a particular embodiment of the invention, a separating device for separating holding adapters in a conveying device for conveying hanging objects is provided, wherein the separating device comprises two separating elements which are each designed as a disk having a plurality of entrainment elements, designed as pinion teeth, and which are mounted so as to be able to rotate in opposite directions with respect to one another in a plane and are arranged spaced apart from one another in such a manner that holding adapters can be conveyed through the separating elements, wherein pinion teeth are provided as entrainment elements and, in one possible rotational position of the separating elements on an imaginary line between an axis of rotation of a first separating element and an axis of rotation of a second separating element, a pinion tooth of the first separating element and a pinion tooth of the second separating element are located with their end faces opposite one another.

The separating elements of the separating device, which is also referred to as the separator, are designed as a disk and thus flat and are provided with pinion teeth which are suitable for engaging with the holding adapters arranged between the separating elements. The separating elements designed in this manner can also be referred to as star-shaped by reason of their appearance. Preferably, both separating elements have an identical number of pinion teeth.

In the present case, the term “holding adapter” is understood to mean both an empty holding adapter and also a holding adapter with an object fastened thereto. The preferably rollably mounted holding adapter has in particular an engagement element, with which the separating elements or the pinion teeth thereof engage for entrainment. Such an engagement element is disposed in particular on a neck part of the holding adapter or is formed by the neck part of the holding adapter. The engagement element or the neck part is disposed in particular below a rail profile or below a free running rail of the rail profile.

“Mounted so as to be able to rotate in opposite directions” means that the first separating element is mounted so as to be able to rotate in a first direction of rotation, e.g. clockwise, and the second separating element is mounted so as to be able to rotate in a second direction of rotation, directed opposite to the first direction of rotation, e.g. anticlockwise. The separating elements are mounted so as to be able to rotate in a plane, which means that the axis of rotation of the first separating element is different from the axis of rotation of the second separating element.

The separating elements, in particular the axes of rotation thereof, are arranged so far apart from one another that, in a plan view, no overlapping of a pinion tooth of the first separating element with the second separating element can occur and vice versa.

In addition, the separating elements are arranged so closely to one another that in the possible rotational position of the separating elements, in which on the imaginary line between the axis of rotation of the first separating element and the axis of rotation of the second separating element, a pinion tooth of the first separating element and a pinion tooth of the second separating element are located with their end faces opposite one another, no holding adapter, in particular no engagement element of the holding adapter, passes through between the pinion teeth located opposite one another. In this position, the holding adapter is stopped and fixedly held on the pinion teeth located opposite one another. This prevents a holding adapter from sliding through in an undesired manner. It is only when the separating elements are rotated out of this rotational position that it is possible to convey the holding adapter onwards.

The separating elements are disposed on both sides of a conveying path which is formed in particular by rail profiles and along which the holding adapters are conveyed. The separating elements are arranged mirror-symmetrically in relation to the conveying path. Thus, in the case of the separating device in accordance with the invention, no rotational offset is provided between the pinion teeth of the first separating element and the pinion teeth of the second separating element.

Alternatively, provision can be made that the separating device only has only a single separating element which is designed as a disk having a plurality of entrainment elements designed as pinion teeth. Such a separating device then comprises, in addition to the single separating element, a flat counter-holding element which is designed in particular as a counter-holding plate. In this embodiment, the separating element and the counter-holding element are arranged in such a way that, in one possible rotational position of the separating element on an imaginary line which extends orthogonally to a counter-holding surface of the counter-holding element and intersects the axis of rotation of the separating element, the end face of a pinion tooth of the separating element is located opposite the counter-holding surface.

The separating device is disposed upstream of one, a plurality or all of the decision points or applications of the conveying device, as seen in particular in the conveying direction. In addition or alternatively, the separating device is disposed downstream of an accumulation-generating portion of the conveying device, in particular an accumulating conveyor or an inclined section, in particular as seen in the conveying direction.

By means of the separating device in accordance with the invention, the use of pneumatics is not required. Moreover, the separating device in accordance with the invention enables increased process safety compared to a separating device having a linearly movable separating element, since it is not possible for more than one holding adapter to pass through.

In addition, the separating device in accordance with the invention has the advantage that it can run endlessly in one direction and thus does not have to run through a cycle for separation purposes, i.e. no time is required for the separating element to return to a starting position. Therefore, compared to the known separating device, a higher throughput of the separating device and thus a higher performance of the conveying device can be achieved. Likewise, the maintenance outlay is less than in the case of the known solution.

In a particular embodiment, provision is made that, as seen in the direction of rotation of the respective separating element, a front flank of at least one of the pinion teeth is steeper than a rear flank of the same pinion tooth. Each pinion tooth of each of the two separating elements may be provided with flanks designed in this manner.

The front steep flank of the pinion tooth serves to press or push the holding adapters out of the separating device. When leaving the separating device, the holding adapter can thus be accelerated to a speed equal in particular to that of a conveyor or take-off conveyor provided downstream of the separating device in the conveying direction. However, the rear, flatter flank of the pinion tooth serves to receive the holding adapter or the engagement element thereof in a friction-free manner. The shape of the pinion teeth is thus designed such that that a collision of the separating elements with a holding adapter to be received, in particular with the engagement element thereof, is avoided, in particular that the holding adapter or the engagement element thereof is not jammed between the pinion teeth of the two separating elements.

In accordance with a further aspect of the invention, provision is likewise made that the two separating elements are connected to one another via force-transmitting and/or rotational speed-transmitting connecting elements. The connecting elements comprise preferably a shaft, to which one of the separating elements is connected. The connecting elements can also comprise a plurality of shafts, wherein then e.g. the first separating element can be connected to a first shaft and the second separating element can be connected to a second shaft. In addition, the connecting elements can comprise e.g. a coupling element, in particular a shaft coupling.

In an advantageous manner, the connecting elements comprise a gear mechanism having a transmission ratio of preferably 1:1. In a particular embodiment, the gear mechanism has two gear wheels, wherein each of the gear wheels is connected to a separating element. It is then e.g. feasible that the first and second separating elements are connected in such a way, in which the first separating element is connected to a first shaft and the first shaft is connected to a first gear wheel of the gear mechanism, the first gear wheel engages with a transmission ratio of 1:1 into a second gear wheel of the gear mechanism and the second gear wheel is connected to a second shaft and the second shaft is connected to the second separating element.

In an advantageous manner, provision can be made that the separating device has a housing for mounting at least one of the separating elements, wherein the separating element is mounted on the housing preferably by means of a rolling bearing, in particular a ball bearing. Both separating elements can also be mounted on the housing. If one of the separating elements is connected to a shaft, provision can be made e.g. that the separating element is mounted on the housing via the shaft and this is then mounted on the housing preferably by means of two ball bearings.

In a further particular embodiment, provision is made that the separating device comprises a rotating actuator, preferably an electric motor, preferably a stepping motor, wherein a rotation of at least one of the separating elements can be effected with the actuator. The rotating actuator is to be distinguished in particular from a drive chain or drive belt. The actuator can be connected e.g. by means of a coupling element to a shaft which, for its part, is connected to the separating element. It is also feasible that the actuator is alternatively or additionally connected to the separating element by means of an angle gear, in particular a bevel gear.

The rotating actuator can also be used to hold the separating element in a desired position, i.e. a counter-force can be applied by the actuator to a force produced by, in particular accumulated, holding adapters. In the case of the embodiment as a stepping motor, the stepping motor is in particular designed and configured such that the separating element is further rotated by a predetermined angle of rotation or a pinion tooth during each activation of the stepping motor and the separating element is held in position between the activations. A rotation of both separating elements can be effected with a single actuator, wherein the separating elements are then connected to one another for this purpose via connecting elements. The separating device can be controlled via a central controller of the conveying device or alternatively via a separate control unit which is allocated to the separating device.

The invention is further directed to a system comprising holding adapters and a separating device in accordance with the invention, wherein the pinion teeth are arranged with respect to one another in such a manner that only a single holding adapter, in particular a single engagement element of a holding adapter, is accommodated in a region formed by two adjacent pinion teeth of the first separating element and two adjacent pinion teeth of the second separating element.

A region is thus formed or spanned by the spacing between two adjacent pinion teeth on the first separating element and the spacing between two adjacent pinion teeth on the second separating element as well as the arrangement of the two separating elements with respect to one another. Only a single holding adapter or the engagement element thereof fits into this region and so only the one holding adapter can be “released” by the separating device during a separation procedure. In particular, the region is optimised by the shape of the pinion teeth with regard to friction-free reception of the holding adapter or the engagement element thereof, wherein, as seen in the direction of rotation of the respective separating element, a front flank of at least one of the pinion teeth is steeper than a rear flank of the same pinion tooth.

With the separating device in accordance with the invention, it is thus possible to ensure that only one holding adapter is separated in each case. This means that there is no requirement for sensor technology to verify that in each case only one holding adapter passes through the separating device during a separation procedure. However, a sensor can be provided which detects whether any holding adapter at all is located in the region which is also referred to as the separating region. The data from such a sensor could be used for targeted control of the separating elements.

In an advantageous embodiment, the system comprises a rail profile for mounting and guiding the holding adapters, wherein each of the two separating elements is connected to a shaft and the shafts are disposed on both sides of the rail profile. A shaft connected to the first separating element is then disposed on one side of the rail profile, e.g. on the right as seen in the conveying direction, and a shaft connected to the second separating element is disposed on the other side of the rail profile, e.g. on the left as seen in the conveying direction.

In addition, provision can be made in an advantageous manner that the housing of the separating device engages at least partially around the rail profile. “To engage partially around” means that the housing is disposed on and next to the rail profile or underneath and next to the rail profile. It is also possible for the housing to engage completely around the rail profile and then to be disposed next to, on and underneath the rail profile, wherein, even if said housing engages completely around said rail profile, a region remains free for conveying the holding adapters. Alternatively, the housing can also be designed in such a manner that it is disposed merely on the rail profile or next to the rail profile or underneath the rail profile.

The invention is also directed to a method for separating holding adapters in a conveying device for conveying hanging objects. The separation is effected by means of a separating device having two separating elements which are each designed as a disk having a plurality of entrainment elements, designed as pinion teeth, and which are mounted so as to be able to rotate in opposite directions with respect to one another in a plane and are disposed on both sides of a conveying path with holding adapters to be separated.

The method in accordance with the invention makes provision that the pinion teeth are arranged with respect to one another such that only a single holding adapter, in particular the engagement element of the single holding adapter, is accommodated in a region formed by two adjacent pinion teeth of a first separating element and two adjacent pinion teeth of a second separating element, and the separating elements are rotated in opposite directions with respect to one another by a specified angle of rotation in order to detach and thus separate the single holding adapter from an, in particular accumulated, group of holding adapters. In other words, in the case of the method, also referred to as the separating method, two separating elements disposed on both sides of the conveying path, which is formed in particular by a rail profile, are simultaneously or synchronously rotated by a specified angle of rotation in order to separate a holding adapter and thus carry out a separating procedure.

The specified angle of rotation, by which the separating elements are rotated during each separating procedure, is determined by the number of pinion teeth. A separating procedure corresponds in particular to an angle of rotation of 360° divided by the number of pinion teeth on one of the separating elements. In other words, for each separation, the separating elements are rotated one pinion tooth further. During such a rotation, a holding adapter lying at the front in the conveying direction is pressed out or pushed out by means of the separating elements on an output side of the separating device. Since no offset is provided between the pinion teeth of the first separating element and the pinion teeth of the second separating element, the pressing out or pushing out is effected with in each case one pinion tooth—engaging with the holding adapter—of each of the two separating elements. In addition, during such a rotation, a possibly subsequent holding adapter is received into the region between the separating elements and is fixedly held at this location.

In a preferred embodiment in the case of the separating device used for the method, as seen in the direction of rotation of the respective separating element, a front flank of at least one of the pinion teeth is steeper than a rear flank of the same pinion tooth. In addition, the separating device used for the method comprises preferably a rotating actuator, with which the rotation of the separating elements is effected.

The method in accordance with the invention renders it possible, between holding adapters, which are fed to the separating device, in particular by reason of the upstream accumulation-generating portion, in a group without any spacing from one another or with an undefined and possibly varying spacing from one another, to create a defined spacing so that the holding adapters can be handled further individually and thus in a process-safe manner at the downstream decision points or applications of the conveying device. The defined spacing is preferably constant over a specific number of holding adapters. However, it is also feasible that the spacing for each pair of adjacent holding adapters is defined individually, i.e. can be configured variably.

With the method in accordance with the invention, only rotation of the separating elements in one direction is required. It is not required to return the separating element to a starting position.

Further details of the invention will become clear from the following description of exemplified embodiments by reference to the drawings.

### BRIEF DESCRIPTION OF THE DRAWINGS

FIG. 1 shows a sectional view of four holding adapters and a schematic plan view of an embodiment of the separating device in accordance with the invention at a first time;

FIG. 1a shows a sectional view of four holding adapters and a schematic plan view of an embodiment of the separating device of FIG. 1 at a second time;

FIG. 2 shows a schematic perspective view of a system having an embodiment of the separating device in accordance with the invention;

FIG. 3 shows a combined side and sectional view of the system of FIG. 2;

FIG. 4 shows a schematic perspective view of a system having a further embodiment of the separating device in accordance with the invention; and

FIG. 5 shows a combined side and sectional view of the system of FIG. 4.

### DESCRIPTION OF THE PREFERRED EMBODIMENTS

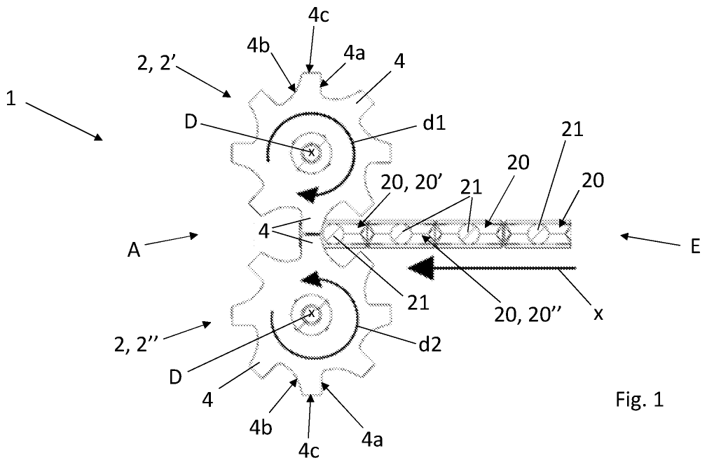

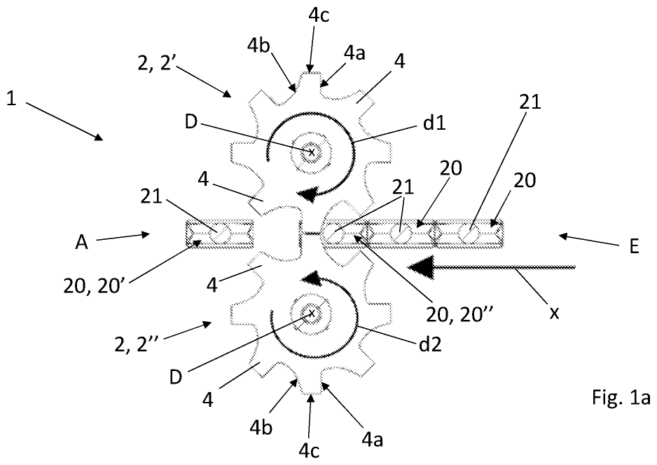

FIG. 1 shows a sectional view of four holding adapters 20 and a schematic plan view of an embodiment of the separating device 1 in accordance with the invention at a first time. FIG. 1a shows a sectional view of four holding adapters 20 and a schematic plan view of the embodiment of the separating device 1 of FIG. 1 at a second time. The second time differs from the first time, wherein the second time of FIG. 1a is later than the first time of FIG. 1.

The separating device 1 in the illustrated embodiment has two disk-shaped separating elements 2 which are mounted so as to be able to rotate in opposite directions with respect to one another in a plane and in each case about an axis of rotation D. To this end, a first separating element 2′ is mounted so as to be able to rotate in a first direction of rotation d1 or clockwise and a second separating element 2″ is mounted so as to be able to rotate in a second direction of rotation d2 or anticlockwise. The separating elements 2 are arranged mirror-symmetrically on both sides of a conveying path which is provided for conveying holding adapters 20. The holding adapters 20 which can be conveyed in a conveying direction x can be conveyed through the two separating elements 2. The conveying direction x extends such that it “harmonises” with the first direction of rotation d1 and the second direction of rotation d2.

The separating elements 2 have entrainment elements which are designed as pinion teeth 4. The pinion teeth 4 are suitable for entraining the holding adapters 20, in particular by engaging with an engagement element 21 of the retaining adapter 20. In the illustrated exemplified embodiment, both separating elements 2 each have eight pinion teeth 4.

It is readily apparent that, as seen in the direction of rotation d of the respective separating element 2, a front flank 4a of the pinion teeth 4 is steeper than a rear flank 4b of the pinion teeth 4. This allows the engagement element 21 of a first holding adapter 20′ (see FIG. 1) or the engagement element 21 of a second holding adapter 20″ (see FIG. 1a) to be received in a friction-free manner into a region between two adjacent pinion teeth 4 of the first separating element 2′ and two adjacent pinion teeth 4 of the second separating element 2″. The region is designed in such a manner that only a single engagement element 21 fits into it or is accommodated therein.

It can likewise be clearly seen that, in the illustrated rotational position of the separating elements 2 on an imaginary line between the axis of rotation D of the first separating element 2′ and an axis of rotation D of the second separating element 2″ a pinion tooth 4 of the first separating element 2′ and a pinion tooth 4 of the second separating element 2″ are located with their end faces 4c opposite one another. The four holding adapters 20 (see FIG. 1) or the three holding adapters (see FIG. 1a) are accumulated in a group at the thus disposed pinion teeth 4 on an input side E of the separating device 1 at the times shown.

In the separating method, the separating elements 2 are simultaneously or synchronously rotated in opposite directions with respect to one another by a specified angle of rotation in order to detach and to separate the first holding adapter 20′ (see FIG. 1) or the second holding adapter 20″ (see FIG. 1a) lying at the front in the conveying direction from the accumulated group of holding adapters 20 and thus to carry out a first separating procedure.

The specified angle of rotation, by which the separating elements 2 are rotated during each separating procedure, is determined by the number of pinion teeth 4. A separating procedure corresponds in particular to an angle of rotation of 360 degrees divided by the number of pinion teeth 4 on one of the separating elements. In the present case, the angle of rotation 360 degrees divided by eight pinion teeth 4 is equal to 45 degrees. During such a rotation (not shown), the first holding adapter 20′ (see FIG. 1) or second holding adapter 20″ (see FIG. 1a) lying at the front in the conveying direction is pressed out or pushed out on an output side A of the separating device 1 by means of the two pinion teeth 4 engaging with said holding adapters.

At the time shown in FIG. 1a, the first holding adapter 20′ is already separated. As can be seen in FIG. 1a, the subsequent second holding adapter 20″ is fixedly held on the pinion teeth 4, in particular on the same pinion teeth 4, with which the first holding adapter 20′ was previously pressed out or pushed out. The second holding adapter 20″ is then already received into the region between the separating elements 2.

The previously described separating procedure is repeated in order to separate the second holding adapter 20″ and further holding adapters 20.

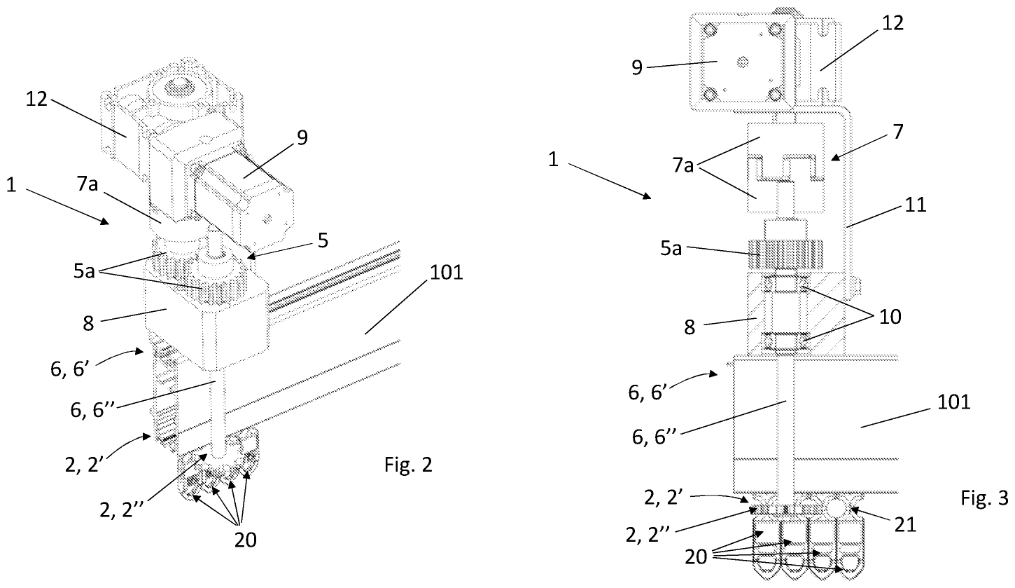

FIG. 2 shows a schematic perspective view of a system having an embodiment of the separating device 1 in accordance with the invention. FIG. 3 shows a combined side and sectional view of the system of FIG. 2. The system comprises, in addition to the separating device 1, a rail profile 101 and four holding adapters 20 which are mounted and guided in the rail profile 101. The holding adapters 20 each have an engagement element 21 which, in the present case, is formed by a neck part of the holding adapter 20 disposed below the rail profile 101. The separating device 1 has, in addition to the separating elements 2, an actuator 9, an angle gear 12, a shaft coupling 7, a gear mechanism 5, a housing 8 and a first shaft 6′ and a second shaft 6″.

In the present case, the actuator 9 is designed as an electric motor, more specifically as a stepping motor. The first shaft 6′ is driven by the actuator 9, wherein the angle gear 12 and the shaft coupling 7 are disposed between the first shaft 6′ and the actuator 9. The shaft coupling 7 comprises two coupling elements 7a, wherein one of the coupling elements 7a is connected to the first shaft 6′ and the other coupling element 7a is connected to an output shaft of the angle gear 12. Alternatively, in an embodiment without an angle gear 12, the latter coupling element 7a can also be directly connected to the actuator 9, in particular to the rotor thereof.

In the illustrated embodiment, the housing 8 is disposed on the rail profile. The actuator 9 and the angle gear 12 are fastened to the housing 8 via an L-shaped bracket 11. In the present case, the bracket 11 is fastened by means of a screw connection. However, it is possible to use any other type of connection, such as e.g. a form-fitting connection.

The gear mechanism 5 has two gear wheels 5a which are the same size, have the same number of teeth and engage with one another. Therefore, in the present case the gear mechanism 5 has a transmission ratio of 1:1. In the illustrated embodiment, the gear wheels 5a are disposed outside the housing 8. It is feasible that, alternatively, they are disposed inside the housing 8.

The first shaft 6′ is connected to one of the gear wheels 5a and moreover to the first separating element 2′ (not shown). The second shaft 6″ is connected to the further gear wheel 5a and moreover to the second separating element 2″. The first separating element 2′ and the second separating element 2″ have the pinion teeth 4 in accordance with the invention. Both shafts 6 are mounted on the housing 8 via, in each case, two ball bearings 10. In FIG. 3, the bearing of the second shaft 6″ can be clearly seen. The ball bearings 10 are disposed spaced apart from one another. The first shaft 6′, not shown, is similarly mounted on the housing 8. The shafts 6 are disposed on both sides of the rail profile 101. However, only the second shaft 6″ can be seen in the figure. The first shaft 6′ cannot be seen because it is covered by the rail profile 101.

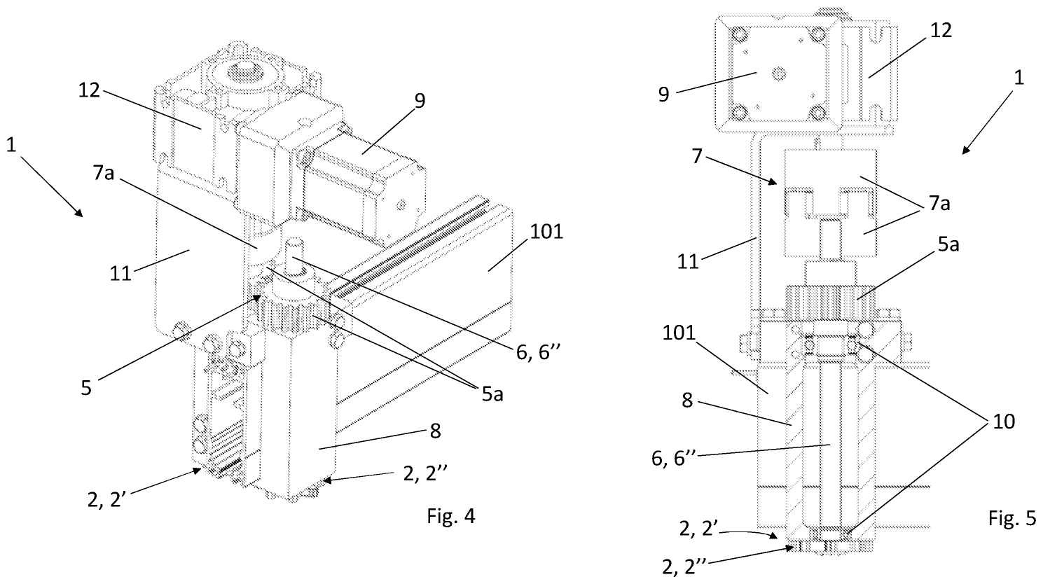

FIG. 4 shows a schematic perspective view of a system having a further embodiment of the separating device 1 in accordance with the invention. FIG. 5 shows a combined side and sectional view of the system of FIG. 4.

The embodiment shown in FIGS. 4 and 5 differs from the embodiment shown in FIGS. 2 and 3 in terms of the design of the housing 8. While the housing 8 in the embodiment shown in FIGS. 2 and 3 is disposed on the rail profile 101, the housing 8 of the embodiment shown in FIGS. 4 and 5 is disposed on, next to and underneath the rail profile 101 and thus engages around it completely. Alternatively, it is feasible to have embodiments, in which the housing 8 engages merely partially around the rail profile 101.

By reason of the housing 8 configured in this manner, in particular the mounting of the two shafts 6 can be effected differently to the mounting shown in FIGS. 2 and 3, wherein the two ball bearings 10 are arranged at a greater spacing from one another. Otherwise, the description relating to FIGS. 2 and 3 applies analogously to FIGS. 4 and 5. However, even if no holding adapters 20 are shown in FIGS. 4 and 5, they can be mounted and guided in the rail profile and can be separated by the illustrated separating device 1 in precisely the same way as in the embodiment shown in FIGS. 2 and 3.

Changes and modifications in the specifically described embodiments can be carried out without departing from the principles of the present invention which is intended to be limited only by the scope of the appended claims, as interpreted according to the principles of patent law including the doctrine of equivalents. The priority German application no. DE 10 2022 103 809.2, filed on Feb. 17, 2022, is hereby incorporated by reference, in particular for support with regard to the translation for the present disclosure.

1. A separating device for separating holding adapters in a conveying device for conveying hanging objects, wherein the separating device comprises:
first and second separating elements that are each configured as a disk having a plurality of entrainment elements configured as pinion teeth, wherein the separating elements are mounted so as to be able to rotate in opposite directions with respect to one another in a plane and are spaced apart from one another such that holding adapters can be conveyed through the separating elements;
wherein in one possible rotational position of the separating elements on an imaginary line between an axis of rotation of the first separating element and an axis of rotation of the second separating element, a pinion tooth of the first separating element and a pinion tooth of the second separating element are located with their end faces opposite one another.

2. The separating device as claimed in claim 1, wherein, as seen in the direction of rotation of the respective separating element, a front flank of at least one of the pinion teeth is steeper than a rear flank of the same pinion tooth.

3. The separating device as claimed in claim 2, wherein the first and second separating elements are connected to one another via torque-transmitting and/or rotational speed-transmitting connecting elements.

4. The separating device as claimed in claim 3, wherein the connecting elements comprise a gear mechanism having a transmission ratio of 1:1.

5. The separating device as claimed in claim 1, further comprising a housing for mounting at least one of the first and second separating elements.

6. The separating device as claimed in claim 5, wherein the at least one of the first and second separating elements mounted on the housing is mounted via a rolling bearing

7. The separating device as claimed in claim 6, wherein the rolling bearing comprises a ball bearing.

8. The separating device as claimed in claim 1, further comprising a rotating actuator, and wherein a rotation of at least one of the first and second separating elements can be effected with the actuator.

9. The separating device as claimed in claim 8, wherein the rotating actuator comprises an electric motor.

10. The separating device as claimed in claim 9, wherein the electric motor comprises a stepping motor.

11. The separating device as claimed in claim 1, wherein the first and second separating elements are connected to one another via torque-transmitting and/or rotational speed-transmitting connecting elements.

12. The separating device as claimed in claim 11, wherein the connecting elements comprise a gear mechanism.

13. The separating device as claimed in claim 11, further comprising a housing for mounting at least one of the first and second separating elements.

14. The separating device as claimed in claim 11, further comprising a rotating actuator, and wherein a rotation of at least one of the first and second separating elements can be effected with the actuator.

15. A system comprising holding adapters and a separating device:
wherein the separating device comprises first and second separating elements that are each configured as a disk having a plurality of entrainment elements configured as pinion teeth, and wherein the separating elements are mounted so as to be able to rotate in opposite directions with respect to one another in a plane and are spaced apart from one another such that holding adapters can be conveyed through the separating elements;
wherein in one possible rotational position of the separating elements on an imaginary line between an axis of rotation of the first separating element and an axis of rotation of the second separating element, a pinion tooth of the first separating element and a pinion tooth of the second separating element are located with their end faces opposite one another; and
wherein the pinion teeth are arranged with respect to one another such that only a single holding adapter is accommodated in a region formed by two adjacent pinion teeth of the first separating element and two adjacent pinion teeth of the second separating element.

16. The system as claimed in claim 15, wherein an engagement element of the single holding adapter is accommodated in the region formed by two adjacent pinion teeth of the first separating element and two adjacent pinion teeth of the second separating element.

17. The system as claimed in claim 15, further comprising a rail profile for mounting and guiding the holding adapters, and wherein each of the first and second separating elements are connected to a shaft and the shafts are disposed on both sides of the rail profile.

18. The system as claimed in claim 17, wherein the separating device comprises a housing for mounting at least one of the first and second separating elements, and wherein the at least one of the first and second separating elements is mounted on the housing by a rolling bearing, and wherein the housing of the separating device engages at least partially around the rail profile.

19. A method for separating holding adapters in a conveying device for conveying hanging objects, said method comprising:
providing a separating device having two separating elements that are each designed as a disk having a plurality of entrainment elements, wherein the entrainment elements are designed as pinion teeth, and wherein the separating elements are mounted so as to be able to rotate in opposite directions with respect to one another in a plane and are disposed on both sides of a conveying path with holding adapters to be separated, and wherein the pinion teeth are arranged with respect to one another in such a manner that only a single holding adapter is accommodated in a region formed by two adjacent pinion teeth of a first one of the separating elements and two adjacent pinion teeth of a second one of the separating elements; and
rotating the separating elements in opposite directions with respect to one another by a specified angle of rotation in order to detach and thus separate the single holding adapter from a group of holding adapters.

20. The method of claim 19, wherein the pinion teeth are arranged with respect to one another such that an engagement element of the single holding adapter is accommodated in the region formed by two adjacent pinion teeth of the first one of the separating elements and two adjacent pinion teeth of the second one of the separating elements, and wherein said rotating the separating elements in opposite directions with respect to one another comprises detaching and separating the single holding adapter from an accumulated group of holding adapters.
